(19) United States
(12) Patent Application Publication
(10) Pub. No.: US 2022/0281017 A1
(43) Pub. Date: Sep. 8, 2022

(54) Method for producing a milled part with a countersinking tool and countersinking tool

(71) Applicant: KENNAMETAL INC., Latrobe, PA (US)

(72) Inventors: Werner Bruno Penkert, Fuerth (DE); Alex Fraese, Fuerth (DE); Peter Gerstner, Fuerth (DE)

(21) Appl. No.: 17/685,745

(22) Filed: Mar. 3, 2022

(30) Foreign Application Priority Data
Mar. 4, 2021 (DE) 102021105286.6

(51) Int. Cl. B23B 51/10

(52) U.S. Cl. CPC B23B 51/10

(57) ABSTRACT

The invention relates to a method for producing a blisk comprising a plurality of blade profiles and channels extending between the blade profiles using a bell-type countersink having a conical lateral surface, wherein the method comprises the steps providing a disk-shaped blank, and, to form the channels in the blank, plunging the bell-type countersink into the blank on a lateral surface of the blank and thereby moving it in a direction along a generating line of the bell-type countersink, wherein the displacement of the bell-type countersink is a 3-axial movement on a linear path and/or a 5-axial movement on a curved path. The invention also relates to a bell-type countersink.

### RELATED APPLICATION DATA

The present application claims priority pursuant to 35 U.S.C. § 119(a) to German Patent Application Number 102021105286.6 filed Mar. 4, 2021 which is incorporated herein by reference in its entirety.

### FIELD

The invention relates to a method for producing a blisk comprising a plurality of blade profiles and channels extending between the blade profiles using a bell-type countersink and a bell-type countersink.

### BACKGROUND

The production of a blisk is generally very time-consuming. Because of the sometimes complicated geometry of the blade profiles, which can be curved and twisted in on themselves, the channels are typically milled only roughly using a side milling cutter or using an end milling cutter or a roughing milling cutter. The remaining material is removed using a form milling cutter.

### SUMMARY

It is therefore an object of the invention to reduce the time required to produce a blisk.

This object is achieved according to the invention by a method for producing a blisk comprising a plurality of blade profiles and channels extending between the blade profiles using a bell-type countersink having a conical lateral surface, wherein the method comprises the following steps:
providing a disk-shaped blank,
to form the channels in the blank, plunging the bell-type countersink into the blank on a lateral surface of the blank and thereby moving it in a direction along a generating line of the bell-type countersink, wherein the displacement of the bell-type countersink is a 3-axial movement on a linear path and/or a 5-axial movement on a curved path.

Using a bell-type countersink makes it possible to better reflect the geometry of the blade profiles during rough-machining, i.e. when roughly machining the blank, than when using a side milling cutter, for example. The time required for rough-machining can consequently be reduced significantly, because rough-machining using a form milling cutter can be eliminated, or the use of a form milling cutter is now necessary only to a limited extent.

If the displacement of the bell-type countersink is 3-axial on a linear path, the advantage is achieved that the programming of the displacement path is less complex, in particular in comparison to the programming of a 5-axial movement.

In this context, a 3-axial movement is understood to be a movement in space that can be defined by three axes, for example a linear movement in a three-dimensional coordinate system. The movement in particular takes place without angular dislocation of the tool axis of the tool relative to the position of the workpiece.

Accordingly, five axes are required to define a movement for a 5-axial movement, for example the three axes of a three-dimensional coordinate system plus two axes of rotation. A 5-axial movement has the advantage that a better alignment of the bell-type countersink to the final contour can be achieved than with a 3-axial movement.

A 5-axial movement of the bell-type countersink can take place during rough-machining and also during semi-finishing and/or finishing.

“Linear” in this context is not necessarily to be understood as rectilinear, but rather as continuous.

However, the movement of the bell-type countersink preferably takes place along a rectilinear path.

Moving the bell-type countersink in a direction along a generating line of the bell-type countersink avoids the occurrence of lateral pressure on the bell-type countersink, which could stress the bell-type countersink and lead to accelerated material fatigue. It in particular achieves that the non-cutting base body of the bell-type countersink moves in an area that has already been cut free. It is also possible to achieve a good alignment of the bell-type countersink to the desired blisk geometry.

The direction along the generating line bell-type countersink extends in particular along a vector that extends rectilinearly along the lateral surface from an imaginary apex of the cone to an imaginary bottom surface of the cone that would be formed if the conical lateral surface of the bell-type countersink were mentally extended. This means that a direction of movement does not extend along a circumferential direction of the lateral surface, i.e. not on a curved path.

The rough-machining and the prefinishing of the blisk is preferably carried out using the bell-type countersink.

Blisk stands for “blade integrated disk” and refers to a bladed wheel made in one piece from a blank.

According to one embodiment, a pre-channel is first formed in the blank at a position between two blade profiles and the pre-channel is then widened in at least one direction by means of the bell-type countersink to form the channels extending between the blade profiles. As a result, only one full-width cut has to be made per channel, which reduces the load on cutting inserts used in the bell-type countersink. The pre-channel can be created using the bell-type countersink. However, it is also possible to create the pre-channel using a side milling cutter or by some other means.

In this context, a pre-channel is a first cut at a position in the blank between two blade flanks, whereby the blade flanks do not exist yet at that point in time, but rather will be created by the subsequent machining.

The pre-channel is formed centrally between two blade profiles, for example, and then widened in both directions toward the blade profiles.

The pre-channel can alternatively be formed on the suction side of a blade profile and then widened toward the pressure side. This sequence is particularly advantageous with respect to the load on the cutting inserts. This in particular avoids the cutting inserts also cutting on their inner side except when forming the pre-channel, which takes place via a full-width cut.

It is also conceivable that the pre-channel is formed on the pressure side and widened toward the suction side.

It is furthermore in principle conceivable to carry out the cut alternating from the pressure and the suction side toward the center of the channel. However, this creates a free-standing, potentially unstable web that could possibly snap off when the bell-type countersink hits it.

When the blank is machined with the bell-type countersink, an allowance of at least 0.3 mm is preferably initially left on the blade profiles. Since the blank is machined at a high cutting speed, the material of the blank heats up considerably, which can lead to a structural change in the material. The allowance ensures that no defective material remains on the final component after final fine machining.

According to one embodiment, the channels are first rough-machined by means of the bell-type countersink to a first depth that is less than a final depth of the channel, and then at least one of the blade flanks adjoining a channel is finished to the first depth at a time. The blade profiles are thus stabilized during machining such that they can withstand the lateral forces that occur during machining and act laterally on the blade profiles. Rough-machining all of the channels to the final depth first and only then finishing the blade profiles would cause the blade profiles to vibrate, in particular when machining near the outer edges, which would make machining more difficult.

After the finishing of the at least one blade flank to the first depth, the channels can be rough-machined to a second depth by means of the bell-type countersink and then the at least one blade flank adjoining the channel can be finished to the second depth. This can be repeated until the final depth is reached. The second depth can also already be the final depth.

One advantage of multistage rough-machining is that the angle of engagement of the bell-type countersink can be changed between the individual machining steps, which allows for a particularly good alignment of the bell-type countersink to the blade profiles. This in particular enables prefinishing by means of the bell-type countersink.

For example, all of the channels are first rough-machined to the first depth and all of the blade flanks are finished to the first depth and then all of the channels are rough-machined to the second depth. This is advantageous in terms of production, because the angle of engagement of the bell-type countersink or a finished tool used can remain unchanged until a machining step has been carried out along the entire periphery of the blank; i.e. equally for all of the channels. Between each machining step, the blank is rotated about its axis by a corresponding angular amount.

Alternatively, it is possible to rough-machine and finish one channel to a final depth first in a multistage rough-machining process, and then machine an adjoining channel by rough-machining and finishing. One advantage of this is that an adjoining channel is not open yet. This means that the blade flank adjoining the as yet unopened channel is supported by solid material and can consequently be machined particularly well.

To machine the blade flanks, in particular when prefinishing, the bell-type countersink is moved along the blade flanks in multiple application directions. This leaves as little residual material as possible on the blade profiles, so that subsequent fine machining is simplified.

Semi-finishing and/or finishing of the channels can likewise be carried out by means of the bell-type countersink, whereby the displacement of the bell-type countersink during finishing is a 5-axial movement. A 5-axial movement makes it possible to move the bell-type countersink on a contact path along a blade flank, whereby the angle of engagement of the bell-type countersink can be changed during the movement.

The finishing by means of the bell-type countersink is in particular carried out last, after the blank has been rough-machined and optionally prefinished.

According to one embodiment, at least two different bell-type countersinks which differ in their flank angle can be used to machine the blank. Machining, in particular on the flanks of the blade profiles can consequently be optimized. A larger curvature is in particular better suited for machining concave flanks of the blade profiles and a smaller curvature is better suited for machining convex flanks of the blade profiles.

The object is further solved according to the invention by a bell-type countersink for carrying out a method as described above, wherein the bell-type countersink comprises a base body having a conical lateral surface and receptacles for cutting inserts are present in the base body.

### BRIEF DESCRIPTION OF THE DRAWINGS

Further advantages and features of the invention result from the following description and from the accompanying drawings, to which reference is made. The drawings show:

FIG. 1 a bell-type countersink according to the invention in a perspective view,

FIG. 2 a bell-type countersink according to the invention in a sectional view,

FIG. 3 a cutting insert in the bell-type countersink in a detail view,

FIG. 4 the bell-type countersink of FIGS. 1 and 2 in an angle of engagement relative to a blisk,

FIG. 5 a bell-type countersink relative to a blisk in a plunged-in state,

FIG. 6 a partial view of a blisk in a plan view onto the blade profiles,

FIG. 7 a schematic plan view of a blade profile,

FIG. 8 a further partial view of a blisk,

FIG. 9 a bell-type countersink when machining a blisk, and

FIG. 10 a removal volume of a bell-type countersink 10.

### DETAILED DESCRIPTION

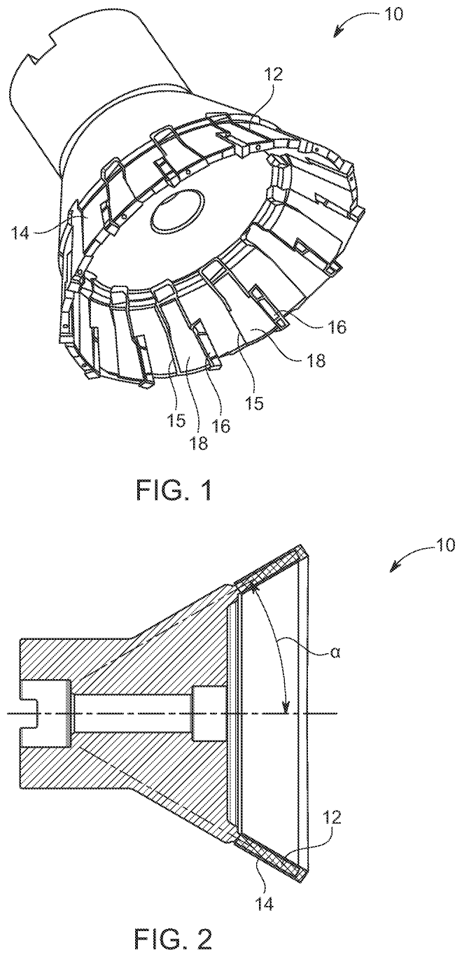

FIGS. 1 and 2 each show a bell-type countersink 10. A countersink is a tool for machining a workpiece.

The bell-type countersink 10 comprises a base body 12 having a conical lateral surface 14, which results in the bell shape of the bell-type countersink 10.

The base body 12 is at least partly hollow, as a result of which the bell-type countersink 10 can plunge particularly deep into a blank to be machined.

A flank angle α of the conical base body 12 shown in FIG. 2 is between 25° and 35°, for example, in particular 30°. The flank angle α is preferably optimized to a geometry to be machined.

In the base body 12 there are receptacles 15, in which cutting inserts 16 are inserted. The cutting inserts 16 are made of ceramic, hard metal, polycrystalline cubic boron nitrate (PCBN) or polycrystalline cubic diamond (PCD), for example.

The cutting inserts 16 are fastened by means of fixing elements 18, which are screwed onto the base body 12.

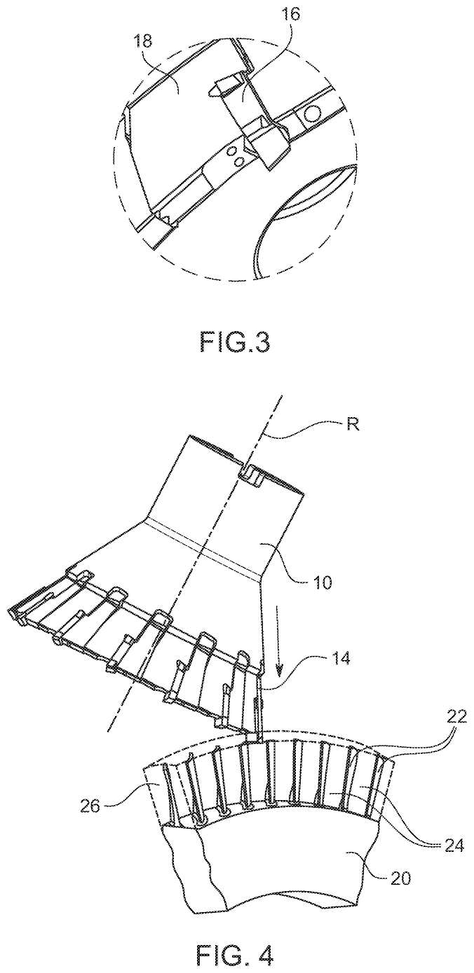

FIG. 3 shows a detail view of a cutting insert 16 fastened by means of a fixing element 18.

The bell-type countersink 10 is suitable for producing a blisk 20 (blade integrated disk), comprising a plurality of blade profiles 22 and channels 24 extending between the blade profiles 22. Such a blisk 20 is illustrated in FIG. 4.

A blisk 20 is typically produced from a disk-shaped blank 26 by machining. In FIG. 4, the geometry of such blank 26 for the blisk 20 is visualized using dashed lines.

To produce the blisk 20, the bell-type countersink 10 is plunged into the blank 26 on a lateral surface 28 of the blank 26 using stabbing movements.

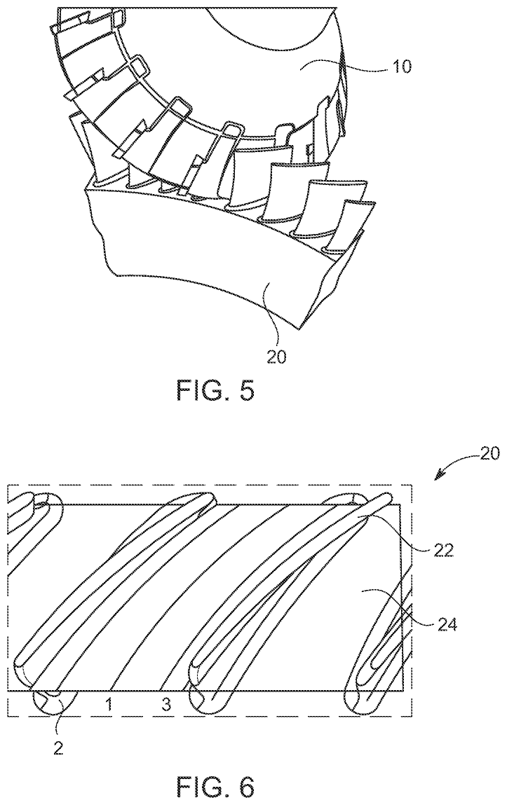

FIG. 4 shows the bell-type countersink 10 in a position prior to being plunged into the blank 26 and FIG. 5 shows it in a plunged-in state.

A direction of movement of the bell-type countersink 10 when plunging into the blank 26 is visualized in FIG. 4 by means of an arrow.

The bell-type countersink 10 is in particular moved in a direction along a generating line of the bell-type countersink 10. More specifically, the displacement of the bell-type countersink 10 takes place on a 3-axial linear path.

In the illustrated design example, the path is rectilinear. The path along which the bell-type countersink 10 is moved is in particular not curved.

The angle of engagement of the bell-type countersink 10 remains constant during a sequence of movements.

It is alternatively also conceivable that the displacement of the bell-type countersink 10 is 5-axial at least in one section.

A 3-axial stabbing movement of the bell-type countersink 10 along a linear path results in an annular groove having approximately the shape of an asymmetrical, elliptical hollow cylinder. FIG. 10 shows an example of a removal volume that can be achieved by the bell-type countersink 10.

A method for producing a blisk 20 from a blank 26 using a bell-type countersink 10 as shown in FIGS. 1 and 2 is explained in the following with reference to FIGS. 6 to 8.

The channels 24 extending between the blade profiles 22 are in particular first rough-machined using the bell-type countersink 10 and optionally also prefinished using the bell-type countersink 10 before a final fine machining of the blisk 20 is carried out.

Coarse machining is generally referred to as rough-machining and fine machining is referred to as finishing.

First, a pre-channel is formed at a position between two blade profiles 22. This can be accomplished by means of the bell-type countersink 10 or by means of another tool, for example by means of a side milling cutter.

The blade profiles 22 are not yet free-standing at this time, but are surrounded by solid material.

The pre-channel is then widened in at least one direction by means of the bell-type countersink 10 to form a channel 24 extending between the blade profiles 22.

FIG. 6 illustrates three examples of penetrations of the bell-type countersink 10 using the lines marked 1, 2, 3. Depending on the spacing of the blade profiles 22 and the width of the cutting inserts 16, however, more than three penetrations may be required.

According to one embodiment of the production method, the pre-channel is formed centrally between the blade profiles 22. This means that a first penetration into the blank 26 takes place along line 1.

The pre-channel extending along line 1 is then widened in both directions by means of the bell-type countersink 10. This means that the next penetrations take place along lines 2, 3.

The penetrations can, however, also be carried out in a different sequence.

The penetrations can be carried out from the suction side toward the pressure side, for example. In other words, the pre-channel is formed near the convex suction side of a blade profile 22 adjoining the channel 24 and the pre-channel is then widened toward the concave pressure side.

With reference to the example illustrated in FIG. 6, the pre-channel is formed along line 3, followed by a penetration along line 1 and lastly a penetration along line 2.

This sequence is particularly suitable when using cutting inserts 16 having a relatively low flank inclination. This avoids the cutting inserts 16 cutting on their inner flank.

Alternatively, it is also conceivable that the penetrations are carried out from the pressure side toward the suction side, i.e. in the sequence 2-1-3 of the penetrations illustrated in FIG. 6.

The machining of the concave pressure side is in particular carried out by an outer flank of the bell-type countersink 10 and the machining of the convex suction side is carried out by the inner flank of the bell-type countersink 10.

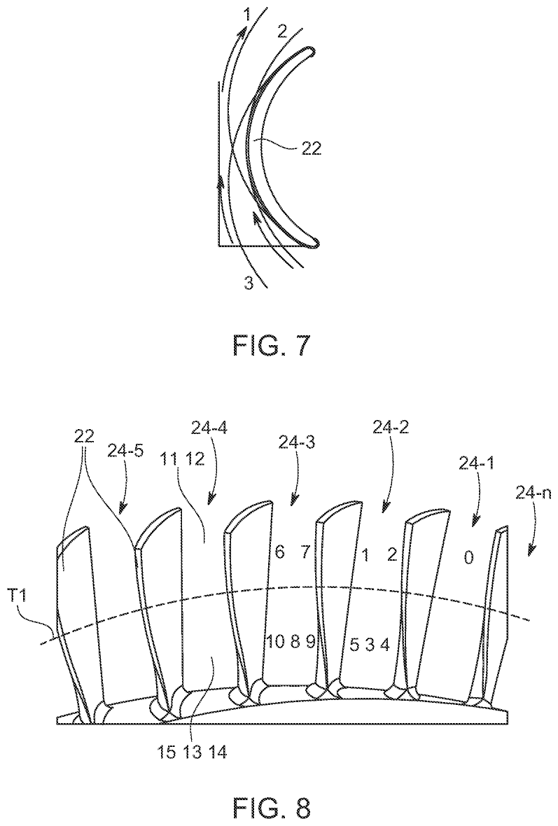

As illustrated in FIG. 7, a plurality of penetrations can be carried out near the suction side of a blade profile 22 using the bell-type countersink 10, whereby the penetrations take place at a different angle of engagement of the bell-type countersink 10 relative to the blank 26. This means that the angle of an axis of rotation R of the bell-type countersink 10 and/or the position of the bell-type countersink 10 relative to the blank 26 is changed between penetrations.

However, here too, penetration takes place in one direction along a generating line of the bell-type countersink 10.

FIG. 7 shows an example of three penetrations along the suction side of a blade profile 22 with different angles of engagement of the bell-type countersink 10.

The three penetrations are visualized in FIG. 7 using numbered lines 1, 2, 3. The respective cutting directions are visualized by means of arrows.

The illustrated penetrations can be carried out in different sequences.

For example, a central penetration, which is visualized in FIG. 7 using line 2, is carried out last. This sequence has the advantage that stabilizing material remains on the center of the flank of the blade profile 22 for as long as possible.

If the cut along line 1 is carried out last, however, the advantage is achieved that the width of the material is as small as possible when leaving the material. This sequence is most gentle on the bell-type countersink 10.

According to an alternative embodiment, only two penetrations can be carried out at a time on the suction side of a blade profile 22 at different angles of engagement of the bell-type countersink 10. In this case, slightly more residual material may remain on the blade flank than with three penetrations.

Carrying out multiple penetrations near the suction side at different angles of engagement of the bell-type countersink 10, achieves that the geometry of the blank 26 can already be particularly well approximated to a final geometry of the blisk 20. This process is also referred to as prefinishing.

This also minimizes allowance fluctuations on the flanks of the blade profiles 22. This simplifies final fine machining.

However, an allowance of at least 0.3 mm remains on the blank 26 after prefinishing.

A maximum allowance is preferably 0.6 mm.

It is also conceivable to use different bell-type countersinks 10 having different flank angles for machining the pressure side and machining the suction side.

A further aspect of a method for producing a blisk 20 using a bell-type countersink 10 is explained with reference to FIG. 8.

Rough-machining and subsequent finishing of the channels 24 can in particular be carried out in multiple stages. This means that a channel 24 is initially not rough-machined to a final depth, but only to a first depth T1. The depth T1 is visualized in FIG. 8 using a dashed line.

Rough-machining and finishing of the channels 24 can in principle be carried out in any number of stages. For the sake of simplicity, the following describes a two-stage machining operation.

Before the channel 24 is rough-machined to a final depth, the channel 24 is finished to the first depth T1. This is advantageous in terms of the behavior of the blade profiles 22 during finishing, as will be explained in more detail below.

To make it easier to follow, the various machining positions in FIG. 8 are numbered. The channels 24 in FIG. 8 are also numbered sequentially in accordance with the machining sequence.

FIG. 8 shows an already completely machined blisk 20. However, this blisk 20 is first produced by the method steps described in the following.

For example, first a first channel 24-1 is rough-machined and finished to the final depth at a position 0.

Next, an adjoining channel 24-2 (in FIG. 8, to the left of the first channel) is rough-machined to the first depth T1 at a position 1.

Rough-machining is carried out as described in connection with FIG. 6, for example, i.e. by forming a pre-channel to depth T1, which is then widened.

It is also possible, as described in connection with FIG. 7, to carry out multiple penetrations of the bell-type countersink 10 to the depth T1 at different angles of engagement in the area of a flank of the blade profile 22, in particular a prefinishing.

When the channel 24-2 has been rough-machined to the first depth T1, a flank of the blade profile 22 delimiting the channel 24-2 to the previously machined channel 24-1 is finished to the first depth T1 at a position 2.

The blade profile 22 is advantageously stabilized in the area above the first depth T1 during finishing by the solid material located below the first depth T1, so that no or only minor vibrations occur in the blade profile 22 during finishing. A lever arm is in particular shortened during finishing.

The channel 24-2 is then rough-machined and finished in a similar manner at positions 3 and 4 to a second depth, which corresponds to the final depth in the illustrated design example.

The flank face of the blade profile 22, which delimits the channel 24-2 to the as yet unmachined channel 24-3, is then finished to the final depth at position 5. The blade profile 22 is hereby supported by the solid material of the as yet unmachined channel 24-3.

The multistage machining makes it possible to change the angle of engagement of the bell-type countersink 10 between the machining steps. The rough-machining to the first depth T1 can in particular be carried out with a different angle of engagement of the bell-type countersink 10 than the rough-machining to the final depth.

The subsequent channels 24-3, 24-4, etc. are then machined in the same manner as channel 24-2, until all of the channels 24 are formed.

In the case of the last channel 24-n, the finishing of the two flanks has to be carried out in multiple stages, because the adjoining blade profile 22 cannot be stabilized since the channel 24-1 has already been opened.

In an alternative embodiment, in contrast to the sequence described above, one and the same method step can be carried out first for each channel 24.

This means that all of the channels 24 can initially be rough-machined to the first depth T1, for example. Rough-machining is in particular carried out at positions 1, 6, 11, etc.

In this case, the bell-type countersink 10 successively carries out the same penetration in all of the channels 24. For this purpose, the blank 26 is rotated so far about its central axis between each penetration that the bell-type countersink 10 can successively plunge into all of the channels 24.

Once all of the channels 24 have been rough-machined to the first depth T1, the blade profiles 22 are finished to the first depth T1 on both flanks, i.e. on the pressure side and on the suction side.

All of the channels 24 are then rough-machined and finished to the final depth in the same manner.

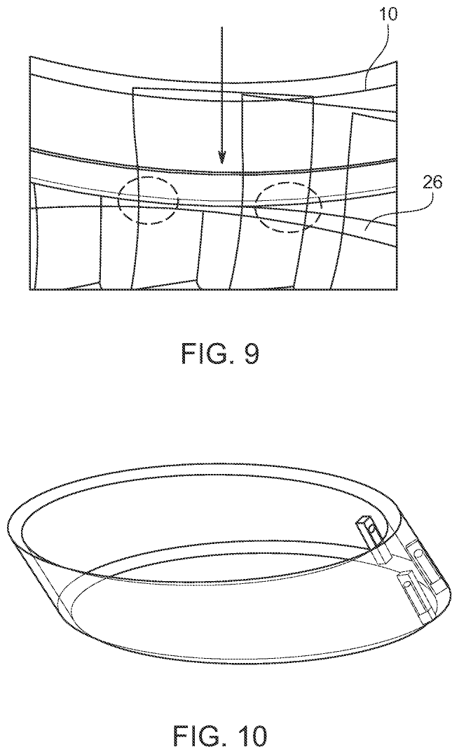

As can be seen in FIG. 9, due to the shape and angle of engagement of the bell-type countersink 10 on the bottom, a greater amount of residual material remains in the area of a leading edge as well as in the area of a trailing edge.

This residual material is removed with a solid carbide milling cutter, for example.

The residual material can alternatively also be removed with the bell-type countersink 10, in particular by means of a tilting movement of the bell-type countersink 10.

If the rough-machining of the channels 24 is carried out in multiple stages as described in connection with FIG. 8, residual material also remains on the intermediate bottoms. This unevenness has to be taken into account for the starting point of the paths when rough-machining to the second depth.

Lastly, the flanks of the blade profiles can be semi-finished or finished using the bell-type countersink 10. Unlike for rough-machining, the movement of the bell-type countersink 10 for finishing is preferably 5-axial.

For finishing, suitable contact paths on the blade flanks and an associated course of the angle of engagement are determined.

Because the direction of movement during finishing is not necessarily in a direction along the generating line of the base body 12, the cutting inserts 16 cannot be permitted to machine in full width. However, since the channels 24 have already been cleared to a small allowance at the time of finishing, this is not a problem in the present case.

1. A method for producing a blisk comprising a plurality of blade profiles and channels extending between the blade profiles using a bell-type countersink having a conical lateral surface, wherein the method comprises the following steps:
providing a disk-shaped blank,
to form the channels in the blank, plunging the bell-type countersink into the blank on a lateral surface of the blank and thereby moving it in a direction along a generating line of the bell-type countersink, wherein the displacement of the bell-type countersink is a 3-axial movement on a linear path and/or a 5-axial movement on a curved path.

2. The method according to claim 1, wherein first a pre-channel is formed in the blank at a position between two blade profiles and the pre-channel is then widened in at least one direction by means of the bell-type countersink to form the channels extending between the blade profiles.

3. The method according to claim 1, wherein an allowance of at least 0.3 mm is initially left on the blade profiles during machining of the blank with the bell-type countersink.

4. The method according to claim 1, wherein the channels are first rough-machined by means of the bell-type countersink to a first depth that is less than a final depth of the channel, and then at least one of the blade flanks adjoining a channel is respectively finished to the first depth.

5. The method according to claim 4, wherein, after the finishing of the at least one blade flank to the first depth, the channels are rough-machined to a second depth by means of the bell-type countersink and then the at least one blade flank adjoining the channel is finished to the second depth.

6. The method according to claim 4, wherein all of the channels are first rough-machined to the first depth and all of the blade flanks are finished to the first depth and then all of the channels are rough-machined to the second depth.

7. The method according to claim 4, wherein a channel is first rough-machined and finished to a final depth and then an adjoining channel is machined by rough-machining and finishing.

8. The method according to claim 1, wherein, to machine the blade flanks, the bell-type countersink is moved along the blade flanks in a plurality of application directions.

9. The method according to claim 1, wherein the channels are finished by means of the bell-type countersink, wherein the displacement of the bell-type countersink during semi-finishing and/or finishing is a 5-axial movement.

10. The method according to claim 1, wherein at least two different bell-type countersinks which differ in their flank angle are used to machine the blank.

11. A bell-type countersink for carrying out a method according to claim 1, wherein the bell-type countersink comprises a base body having a conical lateral surface and receptacles for cutting inserts are present in the base body.
